(19) United States
(12) Patent Application Publication
(10) Pub. No.: US 2025/0373585 A1
(43) Pub. Date: Dec. 4, 2025

(54) LEARNING APPARATUS, LEARNING SYSTEM, LEARNING METHOD, AND COMPUTER READABLE MEDIUM

(71) Applicant: NEC Corporation, Minato-ku, Tokyo (JP)

(72) Inventor: Takeshi AKAGAWA, Tokyo (JP)

(73) Assignee: NEC Corporation, Minato-ku, Tokyo (JP)

(21) Appl. No.: 18/874,190

(22) PCT Filed: Sep. 30, 2022
(86) PCT No.: PCT/JP2022/036759

§ 371 Date: Dec. 12, 2024

(51) Int. Cl. H04L 9/40; G06N 20/00

(52) U.S. Cl. CPC H04L 63/0428; G06N 20/00

(57) ABSTRACT

A learning apparatus includes: a communication establishment unit configured to establish secure communication with an information terminal arranged in a network of each one of organizations; an acquisition unit configured to acquire a data set for each of the organizations from a corresponding one of the information terminals using the secure communication; a learning unit configured to cause a local model to learn the data set; and an integration unit configured to integrate a plurality of local models which have learned a plurality of data sets.

### TECHNICAL FIELD

The present disclosure relates to a learning apparatus, a learning system, a learning method, and a computer readable medium.

### BACKGROUND ART

Patent Literature 1 discloses a technique for implementing machine learning to build an Artificial Intelligence (AI) model (this AI model is also referred to as a local model) personalized to a user.

### CITATION LIST

### Patent Literature [Patent Literature 1] Published Japanese Translation of PCT International

Publication for Patent Application, No. 2020-531999

### SUMMARY OF INVENTION

### Technical Problem

It has been known that, by integrating a plurality of local AI models, an AI model (also referred to as a global model) with improved performance can be built. A server collects user data, whereby the server is able to build local models and a global model.

In a case where a user is an organization, it is required to collect data owned by each organization, so that it is desired to build a network that connects a plurality of organizations. However, there has been a problem that it is difficult to build a network that connects a plurality of organizations with different approaches to providing security.

In view of the above circumstances, one of objects of example embodiments herein disclosed is to provide a learning apparatus, a learning system, a learning method, and a computer readable medium capable of constructing a global model in a case where networks of a plurality of organizations are not constantly connected.

### Solution to Problem

A learning apparatus according to a first aspect of the present disclosure includes: communication establishment means for establishing secure communication with an information terminal arranged in a network of each one of organizations; acquisition means for acquiring a data set for each of the organizations from a corresponding one of the information terminals using the secure communication; learning means for causing a local model to learn the data set; and integration means for integrating a plurality of local models which have learned a plurality of data sets.

A computation system according to a second aspect of the present disclosure includes: an information terminal arranged in a network of each one of organizations; and a learning apparatus, in which the learning apparatus: establishes secure communication with the information terminal, acquires a data set for each of the organizations from a corresponding one of the information terminals using the secure communication; causes a local model to learn the data set; and integrates a plurality of local models which have learned a plurality of data sets.

In a computation method according to a third aspect of the present disclosure, a computer: establishes secure communication with an information terminal arranged in a network of each one of organizations; acquires a data set for each of the organizations from a corresponding one of the information terminals using the secure communication; causes a local model to learn the data set; and integrates a plurality of local models which have learned a plurality of data sets.

In a non-transitory computer readable medium according to a fourth aspect of the present disclosure, a program for causing a computer to execute: processing for establishing secure communication with an information terminal arranged in a network of each one of organizations; processing for acquiring a data set for each of the organizations from a corresponding one of the information terminals using the secure communication; processing for causing a local model to learn the data set; and processing for integrating a plurality of local models which have learned a plurality of data sets is stored.

### Advantageous Effects of Invention

According to the present disclosure, it is possible to provide a learning apparatus, a learning system, a learning method, and a computer readable medium capable of constructing a global model in a case where networks of a plurality of organizations are not constantly connected to one another.

### BRIEF DESCRIPTION OF DRAWINGS

FIG. 1 is a block diagram showing a configuration of a learning apparatus according to a first example embodiment;

FIG. 2 is a block diagram showing a configuration of a learning system according to a second example embodiment;

FIG. 3 is a block diagram showing a configuration of a learning apparatus according to the second example embodiment;

FIG. 4 is a flowchart showing a flow of an operation for generating a local model; and

FIG. 5 is a block diagram showing a configuration of a learning system according to a third example embodiment.

### EXAMPLE EMBODIMENT

### First Example Embodiment

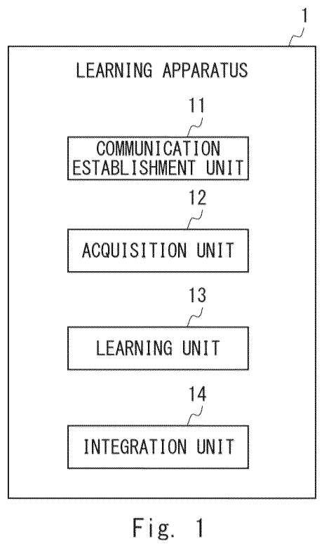

FIG. 1 is a block diagram showing a configuration of a learning apparatus 1 according to a first example embodiment. The learning apparatus 1 includes a communication establishment unit 11, an acquisition unit 12, a learning unit 13, and an integration unit 14. The learning apparatus 1 is connected to a public network (not shown). A network of each one of organizations is connected to the public network. An information terminal (not shown) is arranged in the network of each one of the organizations. The information terminal is a repository in which a data set owned by each organization is accumulated.

The communication establishment unit 11 establishes secure communication with the information terminal arranged in the network of each one of the organizations. The communication establishment unit 11 may establish secure communication at a predetermined timing. The communication establishment unit 11 may establish secure communication based on a degree of progress of learning of a local model that will be described later.

The communication establishment unit 11 causes, for example, the learning apparatus 1 to be connected to the network of each one of the organizations via a Virtual Private Network (VPN). In this case, communication between the learning apparatus 1 and the information terminal is kept confidential by encryption or encapsulating. That is, secure communication is established between the learning apparatus 1 and the information terminal.

Note that the communication establishment unit 11 may establish secure communication using a technique other than the VPN. The communication establishment unit 11 may control communication by protocols including encryption (e.g., SSL/TLS, Secure Shell (SSH), File Transfer Protocol over SSL (FTPS)/TLS).

The acquisition unit 12 acquires a data set for each of the organizations from a corresponding one of the information terminals using secure communication.

The learning unit 13 causes a local model to learn the data set.

The integration unit 14 integrates a plurality of local models which have learned a plurality of data sets.

Note that the learning apparatus 1 includes, as components that are not shown, a processor, a memory, and a storage apparatus. Further, this storage apparatus stores a computer program in which processing of a learning method according to this example embodiment is implemented. Then the processor loads a computer program into the memory from the storage apparatus to execute this computer program. Accordingly, the processor implements functions of the communication establishment unit 11, the acquisition unit 12, the learning unit 13, and the integration unit 14.

Alternatively, each of the communication establishment unit 11, the acquisition unit 12, the learning unit 13, and the integration unit 14 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as the processor.

Further, in a case where some or all of the components of the learning apparatus 1 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the learning apparatus 1 may be provided in the form of Software as a Service (SaaS).

The learning apparatus according to the first example embodiment establishes secure communication with an information terminal connected to a network of each one of the organizations, and acquires a data set using secure communication. Therefore, according to the first example embodiment, it is possible to construct a global model in a case where networks of a plurality of organizations are not constantly connected to one another.

### Second Example Embodiment

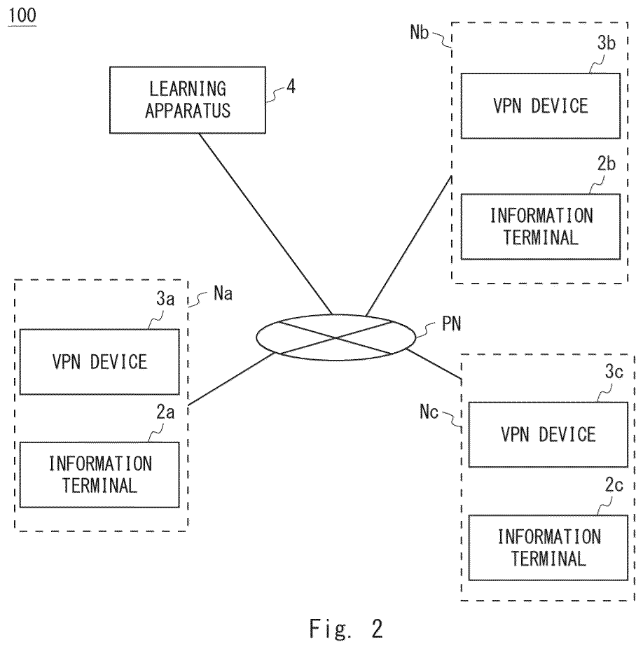

A second example embodiment is a specific example of the first example embodiment. FIG. 2 is a schematic diagram showing a configuration of a learning system 100 according to the second example embodiment. The learning system 100 includes an information terminal 2a, an information terminal 2b, an information terminal 2c, a VPN device 3a, a VPN device 3b, a VPN device 3c, and a learning apparatus 4. The learning apparatus 4 is a specific example of the learning apparatus 1 described above.

The information terminal 2a and the VPN device 3a are disposed in a network Na of an organization A. The information terminal 2b and the VPN device 3b are disposed in a network Nb of an organization B. The information terminal 2c and the VPN device 3c are disposed in a network Nc of an organization C.

A data set owned by the organization A is accumulated in the information terminal 2a. A data set owned by the organization B is accumulated in the information terminal 2b. A data set owned by the organization C is accumulated in the information terminal 2c.

Note that the number of organizations is not limited to three. The number of organizations may be two, or may be four or greater. Each organization is, for example, a pharmaceutical manufacturer or a chemical manufacturer. In this case, the data set is a data set of compounds. Information on the structure of each compound, information on characteristics of each compound and the like are arranged in each record included in the data set of compounds. The structure of each compound is represented by a bit string or the like having a fixed length, and each bit of the bit string represents the presence or absence of a predetermined structure (e.g., benzene ring). Property values (e.g., a value of tensile strength) may be values obtained by experiments or may be values obtained by a simulation or theoretical calculation. For example, data generated daily in research and development work in the organization A is accumulated in the information terminal 2a. As a matter of course, the data set is not limited to a data set of compounds, and may be a data set of any thing.

If it is not necessary to distinguish between the information terminals 2a, 2b, and 2c, they may be simply referred to as an information terminal(s) 2. If it is not necessary to distinguish between the networks Na, Nb, and Nc, they may be simply referred to as a network(s) N. The network N may be a Local Area Network (LAN) or may be a network in which a plurality of LANs are connected to one another. The network N is connected to a public network PN such as the internet.

The VPN device 3 is a VPN server or a router corresponding to the VPN. An Internet Protocol (IP) address or the like of the learning apparatus 4 may be set in the VPN device 3. The VPN may be an internet VPN, an IP-VPN, or a wide area ethernet. If it is not necessary to distinguish between the VPN devices 3a, 3b, and 3c, they may be simply referred to as a VPN device(s) 3.

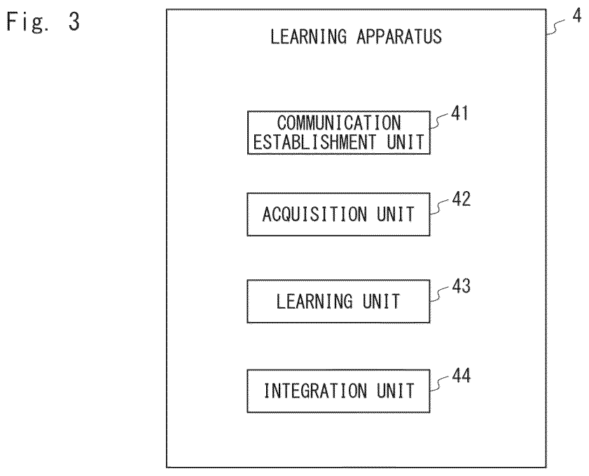

FIG. 3 is a block diagram for describing a configuration of the learning apparatus 4. The learning apparatus 4 is connected to the network PN. The learning apparatus 4 includes a communication establishment unit 41, an acquisition unit 42, a learning unit 43, and an integration unit 44.

The learning apparatus 4 includes a storage that stores local models La, Lb, and Lc. The local model La has learned the data set owned by the organization A. The local model Lb has learned the data set owned by the organization B. The local model Lc has learned the data set owned by the organization C. The local models La, Lb, and Lc are repeatedly updated by the learning unit 43. If it is not necessary to distinguish between the local models La, Lb, and Lc, they may be simply referred to as a local model(s) L.

The communication establishment unit 41 is a specific example of the communication establishment unit 11 described above. The communication establishment unit 41 establishes secure communication with the information terminal 2. Specifically, the communication establishment unit 41 is connected to the VPN device 3 such as a VPN server via a public network PN, and sends a VPN connection request to the VPN device 3. First, TCP/IP connection is established between the learning apparatus 4 and the VPN device 3. Then, the learning apparatus 4 is authenticated, and a VPN session is established between the learning apparatus 4 and the VPN device 3. After the acquisition unit 42 has acquired the data set, the communication establishment unit 41 ends the VPN session. The learning apparatus 4 may be connected to the network N by a remote access VPN.

A timing when the communication establishment unit 41 establishes the secure communication, i.e., a timing when the learning apparatus 4 is connected to the network N via a VPN, will be described later. This is because it is possible that this timing may be related to a degree of progress or the like of processing in the learning unit 43 that will be described later. The timing when the secure communication with the information terminal 2a is established, the timing when the secure communication with the information terminal 2b is established, and the timing when the secure communication with the information terminal 2c is established may be different from one another.

The acquisition unit 42 is a specific example of the acquisition unit 12 described above. After the learning apparatus 4 is connected to the network N via a VPN, the acquisition unit 42 acquires the data set from the information terminal 2.

The learning unit 43 is a specific example of the learning unit 13 described above. The learning unit 43 causes the corresponding local model L to learn the data set acquired by the acquisition unit 42.

The integration unit 44 is a specific example of the integration unit 14 described above. The integration unit 44 integrates the local models La, Lb, and Lc learned in the learning unit 43. The integrated model is referred to as a global model. The integration unit 44 may integrate the local models La, Lb, and Lc at a predetermined timing (e.g., once a day, once in a few months). The performance of the global model is higher than those of the local models La, Lb, and Lc. Further, after the learning of the local models La, Lb, and Lc is completed, the integration unit 44 may perform processing for integrating the local models La, Lb, and Lc.

The integration unit 44 may generate the global model by computing, for example, an arithmetic average of model parameters of the local model La, model parameters of the local model Lb, and model parameters of the local model Lc. Note that the method for integrating the model parameters is not limited to the arithmetic average.

After the integration unit 44 has generated the global model, the learning apparatus 4 distributes the global model to the information terminals 2a, 2b, and 2c. For example, after processing for generating the global model is completed, the learning apparatus 4 may be connected to the networks Na, Nb, and Nc via a VPN in series, and transmit the global model to the information terminals 2a, 2b, and 2c.

Further, the learning apparatus 4 may be connected to the network N via a VPN in response to a request from each information terminal 2 and transmit the global model to the information terminal 2. Each information terminal 2 can import the global model at any timing. The organizations A, B, and C are able to use a high-performance global model in which data sets owned by the plurality of organizations are associated with one another.

Constructing a plurality of local models L and integrating the plurality of local models L is also called federated learning. In this case, it can be said that the learning apparatus 4 performs federated learning. It should be noted, however, that constructing the local models L in local terminals such as the information terminals 2a, 2b, and 2c may instead be referred to as federated learning. In the second example embodiment, the learning apparatus 4 constructs the local models L.

The learning apparatus 4 sequentially repeats processing for establishing secure communication, processing for acquiring a data set, and processing for causing local models to learn the acquired data set. Accordingly, it is possible to improve the performance of the global model based on the data set accumulated in each information terminal 2 on a daily basis. Note that the processing for integrating the plurality of local models may be performed at any timing.

Next, a timing when the communication establishment unit 41 establishes secure communication will be described. The communication establishment unit 41 may establish secure communication at a predetermined timing. The predetermined timing may be once in a few months or may be once in a few days.

Further, the communication establishment unit 41 may establish the secure communication in response to reception of a request from each information terminal 2. The information terminal 2 transmits the request in a case where, for example, an amount of accumulated data sets has become equal to or exceeded a predetermined amount.

The communication establishment unit 41 may establish the next secure communication based on a degree of progress of learning for causing the local model L to learn the data set. In a case where the local model L is caused to learn one data set, the data set is divided into a plurality of batches and the local model L is caused to learn the plurality of batches in series. The processing for dividing the data set into batches and learning the plurality of batches is repeated a predetermined number of times. The predetermined number of times is set in such a way that model parameters of the local model L converge. Note that the predetermined number of times needs to be set to a number small enough to avoid overfitting. After model parameters of the local model have converged, the communication establishment unit 41 may establish the next secure communication.

The degree of progress of the learning may be expressed by the number of repetitions of the learning and the number of batches that have already been learned. In a case where, for example, a data set is divided into five batches and learning is repeated 10 times, the next secure communication may be established after learning has completed, that is, after the 10-th learning has ended. The communication establishment unit 41 may establish the next secure communication at a timing when completion of the learning has approached: for example, after the fourth batch in the 10-th learning has completed.

In a case where the degree of progress of the learning of the local model La, the degree of progress of the learning of the local model Lb, and the degree of progress of the learning of the local model Lc have exceeded thresholds, the communication establishment unit 41 may sequentially establish secure communication with the information terminals 2a, 2b, and 2c. Further, in a case where the degree of progress of learning of any one of the local models L has exceeded a threshold, the communication establishment unit 41 may establish secure communication with the corresponding information terminal 2.

The communication establishment unit 41 may establish the next secure communication based on the degree of progress of the processing for integrating a plurality of local models L. In a case where the processing in the integration unit 44 is not a simple arithmetic average or a case where the number of organizations is large, it may take a long time to complete the processing in the integration unit 44. It is efficient if processing to be performed after the processing in the integration unit 44 is completed can be started after the processing in the integration unit 44 is completed.

Further, in a case where the secure computation technology is applied, it is possible that it may take a long time for processing of the integration unit 44. It is known that the data set used for learning may be estimated by performing reverse engineering on the local model L. It has therefore been desired to perform secure computation for integrating the local models L in order to improve confidentiality of the local models L. The secure computation, which is a technology for performing computation processing while keeping data encrypted, includes, for example, a secure computation technology that uses Multi-Party Computation (MPC) or homomorphic encryption as a known technology.

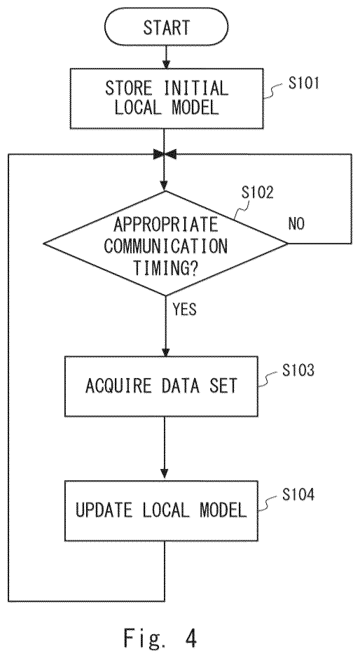

FIG. 4 is a flowchart showing a flow of processing for generating a local model L. It is assumed that the learning apparatus 4 stores an initial local model L (Step S101).

Next, the communication establishment unit 41 of the learning apparatus 4 determines whether or not it is time to establish secure communication (Step S102). If it is not the right time to establish secure communication (NO in Step S102), the process returns to the process in Step S102.

If it is time to establish secure communication (YES in Step S102), the communication establishment unit 41 establishes secure communication between the information terminal 2 and the learning apparatus 4, and the acquisition unit 42 acquires a data set from the information terminal 2 (Step S103). After that, the communication establishment unit 41 ends the secure communication.

In Step S103, a plurality of data sets may be acquired. First, secure communication is established between the information terminal 2a and the learning apparatus 4, the acquisition unit 42 acquires a data set from the information terminal 2a, and the communication establishment unit 41 ends the secure communication. After that, secure communication is established between the information terminal 2b and the learning apparatus 4, the acquisition unit 42 acquires the data set from the information terminal 2b, and the communication establishment unit 41 ends the secure communication. After that, secure communication is established between the information terminal 2c and the learning apparatus 4, the acquisition unit 42 acquires a data set from the information terminal 2c, and the communication establishment unit 41 ends the secure communication. As a matter of course, in Step S103, the data set may be acquired from any one of the information terminals 2a, 2b, and 2c.

Next, the learning unit 43 causes the local model L to learn the data set acquired in Step S103 and updates the local model L (Step S104). If a plurality of data sets have been acquired in Step S103, a plurality of local models L may be updated in Step S104. After the local model L is updated, the process returns to Step S102. Note that the processing for integrating the plurality of local models L may be performed at any timing.

The learning apparatus according to the second example embodiment is connected to the network of each one of the organizations via a VPN at an appropriate communication timing to acquire a data set of this organization. Accordingly, the data set can be received safely and a local model can be constructed at an appropriate timing.

Note that the secure communication is not limited to communication via a VPN. The secure communication may be communication by any secure communication protocol (e.g., encryption protocol). The data set may be transmitted from the information terminal 2 to the learning apparatus 4 by a mail using a secure communication protocol (e.g., S/MIME).

### Modified Example of Second Example Embodiment

The apparatus including the integration unit 44 that generates the global model may be different from the apparatus including the learning unit 43 that constructs the local model L. In this case, the apparatus including the integration unit 44 may establish secure communication (e.g., SSL) with the apparatus including the learning unit 43 and acquire the local model L. Accordingly, it is possible not only to make communication between a repository (e.g., the information terminal 2) where data sets are accumulated and the local model L secure, but also to make communication between the local model L and the global model secure.

### Third Example Embodiment

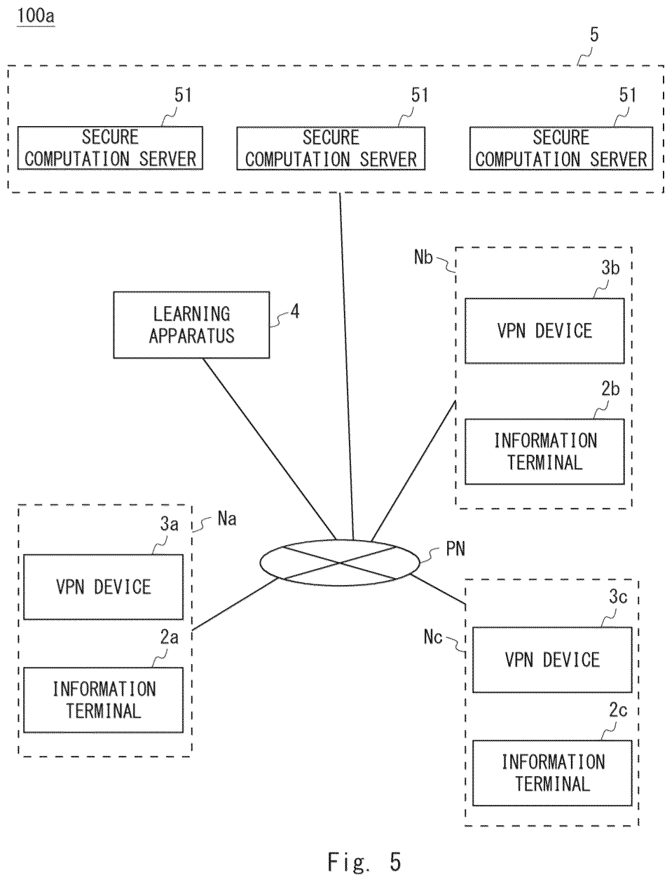

A third example embodiment is a specific example of the second example embodiment. A learning apparatus according to the third example embodiment integrates model parameters of local models by secure computation. FIG. 5 is a block diagram showing a configuration of a learning system 100a according to the third example embodiment. FIG. 5 is different from FIG. 2 in that a server group 5 is added in FIG. 5.

The server group 5 includes a plurality of secure computation servers 51. Note that the number of secure computation servers 51 is not limited to three. However, taking into consideration that secure computation is executed, the number of secure computation servers 51 is preferably three or larger.

The server group 5 integrates a local model La, a local model Lb, and a local model Lc and transmits a result of secure computation to the learning apparatus 4.

An integration unit 44 of a learning apparatus 4 divides model parameters of the local model La into a plurality of (e.g., three) shares, and transmits the plurality of shares to the plurality of secure computation servers 51. The integration unit 44 divides model parameters of the local model Lb into a plurality of shares, and transmits the plurality of shares to the plurality of secure computation servers 51. The integration unit 44 divides model parameters of the local model Lc into a plurality of shares, and transmits the plurality of shares to the plurality of secure computation servers 51.

Each of the secure computation servers 51 performs secure computation for computing a global model using the received shares. The local model is not known from the shares, and it can be said that the computation using the shares is secure computation. The plurality of secure computation servers 51 may perform Multi-Party Computation (MPC) in a cooperative manner. Since an amount of computations required to integrate local models L is sufficiently small, it can be considered that the server group 5 can perform secure computation in a realistic time.

The third example embodiment can achieve effects similar to those in the second example embodiment. Further, according to the third example embodiment, it is possible to keep computations for integrating global models confidential.

The above-described program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present application has been described above with reference to the example embodiments, the present application is not limited to the above-described example embodiments. Various changes that can be understood by those skilled in the art within the scope of the present application can be made to the configurations and the details of the present application.

The whole or part of the example embodiments disclosed above can be described as, but not limited to, the following supplementary notes.

### Supplementary Note 1

A learning apparatus comprising:
communication establishment means for establishing secure communication with an information terminal arranged in a network of each one of organizations;
acquisition means for acquiring a data set for each of the organizations from a corresponding one of the information terminals using the secure communication;
learning means for causing a local model to learn the data set; and
integration means for integrating a plurality of local models which have learned a plurality of data sets.

### Supplementary Note 2

The learning apparatus according to Supplementary Note 1, wherein the communication establishment means establishes a next secure communication based on a degree of progress of learning of the local model.

### Supplementary Note 3

The learning apparatus according to Supplementary Note 1, wherein the communication establishment means establishes a next secure communication in a case where model parameters of the local model have converged.

### Supplementary Note 4

The learning apparatus according to Supplementary Note 1, wherein the communication establishment means establishes the secure communication at a predetermined timing.

### Supplementary Note 5

The learning apparatus according to Supplementary Note 1, wherein the communication establishment means establishes the secure communication in response to reception of a request from each information terminal.

### Supplementary Note 6

The learning apparatus according to Supplementary Note 5, wherein the request is transmitted by the information terminal in a case where an amount of data of the data sets accumulated in the information terminal has exceeded a predetermined amount.

### Supplementary Note 7

The learning apparatus according to Supplementary Note 1, wherein the communication establishment means establishes a next secure communication based on a degree of progress of processing for integrating the plurality of local models.

### Supplementary Note 8

The learning apparatus according to Supplementary Note 7, wherein the integration means integrates the plurality of local models using a secure computation technology.

### Supplementary Note 9

The learning apparatus according to any one of Supplementary Notes 1 to 8, wherein the communication establishment means establishes the secure communication by causing the learning apparatus to be connected to the network via a Virtual Private Network (VPN).

### Supplementary Note 10

A learning system comprising:
an information terminal arranged in a network of each one of organizations; and
a learning apparatus, wherein
the learning apparatus:
   establishes secure communication with the information terminal,
   acquires a data set for each of the organizations from a corresponding one of the information terminals using the secure communication;
   causes a local model to learn the data set; and
   integrates a plurality of local models which have learned a plurality of data sets.

### Supplementary Note 11

The learning system according to Supplementary Note 10, wherein the learning apparatus establishes a next secure communication based on a degree of progress of learning in the local model.

### Supplementary Note 12

A learning method, wherein
a computer:
establishes secure communication with an information terminal arranged in a network of each one of organizations;
acquires a data set for each of the organizations from a corresponding one of the information terminals using the secure communication;
causes a local model to learn the data set; and
integrates a plurality of local models which have learned a plurality of data sets.

### Supplementary Note 13

A non-transitory computer readable medium storing a program for causing a computer to execute:
processing for establishing secure communication with an information terminal arranged in a network of each one of organizations;
processing for acquiring a data set for each of the organizations from a corresponding one of the information terminals using the secure communication;
processing for causing a local model to learn the data set; and
processing for integrating a plurality of local models which have learned a plurality of data sets.

### REFERENCE SIGNS LIST

1, 4 Learning Apparatus
11, 41 Communication Establishment Unit
12, 42 Acquisition Unit
13, 43 Learning Unit
14, 44 Integration Unit
2, 2a, 2b, 2c Information Terminal
3, 3a, 3b, 3c VPN Device
100, 100a Learning System
5 Server Group
51 Secure Computation Server
N, Na, Nb, Nc Network
PN Public Network

What is claimed is:

1. A learning apparatus comprising:
at least one memory storing instructions and
at least one processor further configured to execute the instructions to:
establish secure communication with an information terminal arranged in a network of each one of organizations;
acquire a data set for each of the organizations from a corresponding one of the information terminals using the secure communication;
cause a local model to learn the data set; and
integrate a plurality of local models which have learned a plurality of data sets.

2. The learning apparatus according to claim 1, wherein the at least one processor is further configured to execute the instructions to:
establish a next secure communication based on a degree of progress of learning of the local model.

3. The learning apparatus according to claim 1, wherein the at least one processor is further configured to execute the instructions to:
establish a next secure communication in a case where model parameters of the local model have converged.

4. The learning apparatus according to claim 1, wherein the at least one processor is further configured to execute the instructions to:
establish the secure communication at a predetermined timing.

5. The learning apparatus according to claim 1, wherein the at least one processor is configured to execute the instructions to:
establish the secure communication in response to reception of a request from each information terminal.

6. The learning apparatus according to claim 5, wherein the request is transmitted in a case where an amount of data of the data sets accumulated in the information terminal has exceeded a predetermined amount.

7. The learning apparatus according to claim 1, wherein the at least one processor is further configured to execute the instructions to:
establish a next secure communication based on a degree of progress of processing for integrating the plurality of local models.

8. The learning apparatus according to claim 7, wherein the at least one processor is further configured to execute the instructions to:
integrate the plurality of local models using a secure computation technology.

9. The learning apparatus according to claim 1, wherein the at least one processor is further configured to execute the instructions to:
establish the secure communication by causing the learning apparatus to be connected to the network via a Virtual Private Network (VPN).

10. A learning system comprising:
an information terminal arranged in a network of each one of organizations; and
a learning apparatus, wherein
the learning apparatus:
establishes secure communication with the information terminal,
acquires a data set for each of the organizations from a corresponding one of the information terminals using the secure communication;
causes a local model to learn the data set; and
integrates a plurality of local models which have learned a plurality of data sets.

11. The learning system according to claim 10, wherein the learning apparatus establishes a next secure communication based on a degree of progress of learning in the local model.

12. A learning method, wherein
a computer:
establishes secure communication with an information terminal arranged in a network of each one of organizations;
acquires a data set for each of the organizations from a corresponding one of the information terminals using the secure communication;
causes a local model to learn the data set; and
integrates a plurality of local models which have learned a plurality of data sets.

13. A non-transitory computer readable medium storing a program for causing a computer to execute:
processing for establishing secure communication with an information terminal arranged in a network of each one of organizations;
processing for acquiring a data set for each of the organizations from a corresponding one of the information terminals using the secure communication;
processing for causing a local model to learn the data set; and
processing for integrating a plurality of local models which have learned a plurality of data sets.
